(19) United States
(12) Patent Application Publication
(10) Pub. No.: US 2022/0126843 A1
(43) Pub. Date: Apr. 28, 2022

(54) PROACTIVE VEHICULAR SECURITY SYSTEM

(71) Applicant: Eric J. Dean, Park Forest, IL (US)

(72) Inventor: Eric J. Dean, Park Forest, IL (US)

(21) Appl. No.: 17/647,420

(22) Filed: Jan. 7, 2022

Related U.S. Application Data
(63) Continuation-in-part of application No. 16/653,915, filed on Oct. 15, 2019.
Application No. 16/653,915 is a continuation-in-part of application No. 16/277,118, filed on Feb. 15, 2019, now abandoned.

(51) Int. Cl. B60W 40/13

(52) U.S. Cl. CPC B60W 40/13; B60W 2554/4041; B60W 2420/52

(57) ABSTRACT

A proactive vehicular security system is provided. The proactive vehicular security system embodies a new use for lidar radar providing a lidar radar system operatively associated with a vehicle, the lidar radar system configured to provide a field of view defining a coordinate system adjacent to the vehicle so that each separate object in the field of view can be defined by the coordinate system; the lidar radar system configured to provide a zonal coordinate system for a structural profile of the vehicle wherein a datum of the zonal coordinate system comprises a datum for each zone of a plurality of zones comprising the zonal coordinate system, and wherein changes in the zonal coordinates associated with the structural profile, relative to the datum of the zonal coordinate system, indicates metes and bounds of damage to or additions to the structural profile of the vehicle.

### CROSS-REFERENCE TO RELATED APPLICATION

This continuation-in-part application claims the benefit of priority of U.S. non-provisional application Ser. No. 16/277,118, filed 15 Feb. 2019, and non-provisional application Ser. No. 16/653,915, filed 15 Oct. 2019, the contents of which are herein incorporated by reference.

### BACKGROUND OF THE INVENTION

The present invention relates to vehicle alarm systems and, more particularly, a proactive vehicular alarm system embodying functionality configured to selectively capture and export motion-sensitive audio-video surveillance in and about an associated vehicle. The proactive vehicular alarm system is remotely connected to a portable computing device of the vehicle's owner for alerting the owner in the form of audio and/or video data/information regarding the motion-sensed activity. Such data may include evidence of theft and/or damage to the associated vehicle. Furthermore, the surveillance functionality is built into the vehicle, thereby preventing theft or damage to the present invention.

It is not uncommon for motor vehicle owners to return to their parked truck, car or motorcycle only to discover that their vehicle has been negligently damaged since they left it. Unfortunately, it is also not uncommon for the negligent individual responsible for the damage to flee the scene rather than be accountable. Likewise, thieves generally do not leave a calling card.

With typical audible car alarms, the owner doesn't have an explanation as to why the alarm was activated. And so, they need to decide with very little information to either hurry back to their vehicle or assume there is a false alarm.

Dash cams may provide audio and video evidence of activity in or about a vehicle, however, they have their own disadvantages. First, dash cams are not operatively associated with motion sensors, and so dash cams end up mostly recording the driver and the empty road for hours on end, which a user would have to sift through to find moments of interest. Furthermore, dash cams have blind spots as they only capture a limited portion of the vehicle, such as just the driver and passenger side and the vehicle's posterior, and so the surveillance range of capture of and around the rear window view is typically limited. Also, if the user's vehicle is a pickup with a load or a car full of items, the dash cam can't see out the back window. Additionally, someone can steal the dash cam, requiring re-installation and mounting of the cameras. Also, dash cams are typically an eyesore and their wires tend to clutter the inside of the vehicle. In short, for owners of high-end vehicles or any vehicle owner that appreciates a clean or factory finish, the clutter of the dashboard cameras, and the time and/or expense of mounting and hiding wires, makes dash cams undesirable obstructions of one's view.

As can be seen, there is a need for a vehicle alarm system embodying motion-sensitive, audio-video surveillance functionality remotely connected to a portable computing device of the vehicle's owner for alerting the owner with visual and audio data relevant to the motion and deeds that triggered the motion-sensitive alarm, which may include evidence regarding theft and/or damage to the associated vehicle admissible in a court of law or equity.

The proactive vehicular alarm system, commercially known as “WHIP WATCH”, operatively associates motion sensors to audio-video input devices preset to selectively record captured image within and without the vehicle when the motion sensors are triggered. The captured images may be exported to one or more remote computing devices, giving the owner a heads up to certain recorded evidence related to the triggering motion, which could include information (audio and visual) regarding nearby vehicles and individuals and other details, which can be in turn exported to the appropriate authorities. As a result, the present invention fills the evidentiary gap between hearing one's car alarm and making one's car whole again.

### SUMMARY OF THE INVENTION

In one aspect of the present invention, a computer implemented method of providing a proactive vehicular alarm system includes the following steps: integrating one or more motion sensors into a vehicle so that the one or more motion sensors are; integrating a plurality of video input devices into the vehicle so that the plurality of video input devices is hidden yet provides a bird's eye view of the vehicle; providing a wireless communication processing system operatively associating the one or more motion sensors to the plurality of video input devices, wherein motion detected by the one or more motion sensors activates the plurality of video input devices for a predetermined amount of time; and wherein the wireless communication processing system is configured to electronically export data captured by the plurality of video input devices to a remote computing device. In another aspect of the present invention, the computer implemented method of providing a proactive vehicular alarm system includes the following: integrating one or more motion sensors into a vehicle so that the one or more motion sensors are; integrating a plurality of video input devices into the vehicle so that the plurality of audio and video input devices are adapted to provide a bird's eye view of an exterior of the vehicle, wherein the bird's eye view is provided through the plurality of video input devices being disposed along a passenger-side mirror, a driver-side mirror, a rear portion, and a front portion of the vehicle, and wherein the rear portion includes a license plate area and or a rear roof portion of the vehicle; providing a video input device along an interior of the vehicle; and providing a wireless communication processing system operatively associating the one or more motion sensors to the plurality of audio and video input devices, wherein motion detected by the one or more motion sensors activates the plurality of audio and video input devices for a predetermined amount of time; and wherein the wireless communication processing system is configured to electronically export data captured by the plurality of audio and video input devices to a remote computing device, wherein the plurality of audio and video input devices includes an interior audio and video input device located for capturing exportable data from an interior of the vehicle.

In yet another embodiment, a proactive vehicular security system is provided, wherein the proactive vehicular security system embodies a new use for lidar radar providing a lidar radar system operatively associated with a vehicle, the lidar radar system configured to provide a field of view defining a coordinate system adjacent to the vehicle so that each separate object in the field of view can be defined by the coordinate system; the lidar radar system configured to provide a zonal coordinate system for a structural profile of the vehicle wherein a datum of the zonal coordinate system comprises a datum for each zone of a plurality of zones comprising the zonal coordinate system, and wherein changes in the zonal coordinates associated with the structural profile, relative to the datum of the zonal coordinate system, indicates metes and bounds of damage to or additions to the structural profile of the vehicle.

Additionally, the present invention may include an event database coupled to the lidar radar system for retrievably storing three-dimensional representation of said objects, said damage, and/or said additions in sets of event data, wherein event data is exportable to an owner, insurer, and/or a legal enforcement entity.

In yet another embodiment, a new use for lidar radar for providing a safety system for a vehicle, comprising a plurality of lidar elements disposed along a plurality of exterior surfaces of the vehicle for determining a sag to load ratio, wherein the sag is determined relative between a loaded condition and an unloaded condition of the vehicle, wherein the sag can be determined for each of the plurality of exterior surfaces.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention;

FIG. 4 is a schematic view of an exemplary embodiment of the present invention;

FIG. 5 is a schematic view of an exemplary embodiment of the present invention;

FIG. 6 is a schematic view of an exemplary embodiment of the present invention;

FIG. 7 is a schematic view of an exemplary embodiment of the present invention;

FIG. 8 is a schematic view of an exemplary embodiment of the present invention;

FIG. 9 is a schematic view of an exemplary embodiment of the present invention;

FIG. 10 is a schematic view of an exemplary embodiment of the present invention;

FIG. 11 is a schematic view of an exemplary embodiment of the present invention;

FIG. 12 is a schematic view of an exemplary embodiment of the present invention;

FIG. 13 is a schematic view of an exemplary embodiment of the present invention;

FIG. 14 is a perspective view of an exemplary embodiment of the present invention;

FIG. 15 is a perspective view of an exemplary embodiment of the present invention;

FIG. 16 is a perspective view of an exemplary embodiment of the present invention;

FIG. 17 is a perspective view of an exemplary embodiment of the present invention, wherein AA and BB are signal from the LIDAR elements, and wherein the vertical grid is describing weight or load relative vertical movement. Here, a positive reading is load 00 being removed and negative reading is weight of the load 00 being added. The horizontal grid is load shift relative to or as a result of wind forces, these would be able to tell the driver the direction and force of the wind, thereby alerting the driver of any potential tilt or roll over;

FIG. 18 is a perspective view of an exemplary embodiment of the present invention;

FIG. 19 is a perspective view of an exemplary embodiment of the present invention;

FIG. 20 is an elevational view of an exemplary embodiment of the present invention, wherein the vertical grid in the upper right hand corner is a measurement of wind velocity combined with GPS and LIDAR element readings, enabling an indication of the direction and velocity of the wind hitting the vehicle;

FIG. 21 is an elevational view of an exemplary embodiment of the present invention, wherein C− may be signals produced by the associated LIDAR element that represent load weight, and wherein C+ is positive reading because the relevant LIDAR element is further away from the ground because of uneven weight distribution; and

FIG. 22 is a perspective view of an exemplary embodiment of the present invention, wherein the arrows represent signals produced by the associated LIDAR elements, and wherein the vertical grid represents of load weight added and taken away from vehicle (once load and/or passengers weight values are recorded and accounted for in the vehicles database, any change in values are associated with weight shift, wind velocity, and/or terrane differences that can/will effect vehicle stored values.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

Broadly, an embodiment of the present invention provides a proactive vehicular alarm system embodying a motion sensitive audio-video surveillance functionality remotely connected to a portable computing device of the vehicle's owner for alerting the owner along with visual and audio data relevant to the event that triggered the alarm system, such as evidence regarding theft and damage to an unattended vehicle.

In another embodiment, the present invention provides a proactive 360-degree vehicle security system. The present invention leverages a new use of lidar surveying technology for improving vehicular security. Lidar is a surveying method that measures distance to a target by illuminating the target with laser light and measures the reflected light with a sensor to determine distances between known coordinates and the target. In the present invention, the target is any object (including individuals) who are within a certain proximity of a vehicle, having the known coordinates. The present invention also exploits lidar radar technology to recognize the metes and bounds of any damage that that the object may have inflicted on the vehicle. Using a known coordinate system with known values, such as known longitudinal and latitudinal coordinates, that define a datum from which future changes to the coordinates define the metes and bounds of vehicular damage (for negative longitude and latitude coordinates relative to the datum) or something attached to the vehicle (for positive longitude and latitude coordinates relative to the datum). The recognized damage and coordinates of the object or objects that caused the damage, can be compiled as event data, which is retrievably storable in an event database. The event data is exportable to the owner and relevant third-parties, such as insurance companies and the police department.

The present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

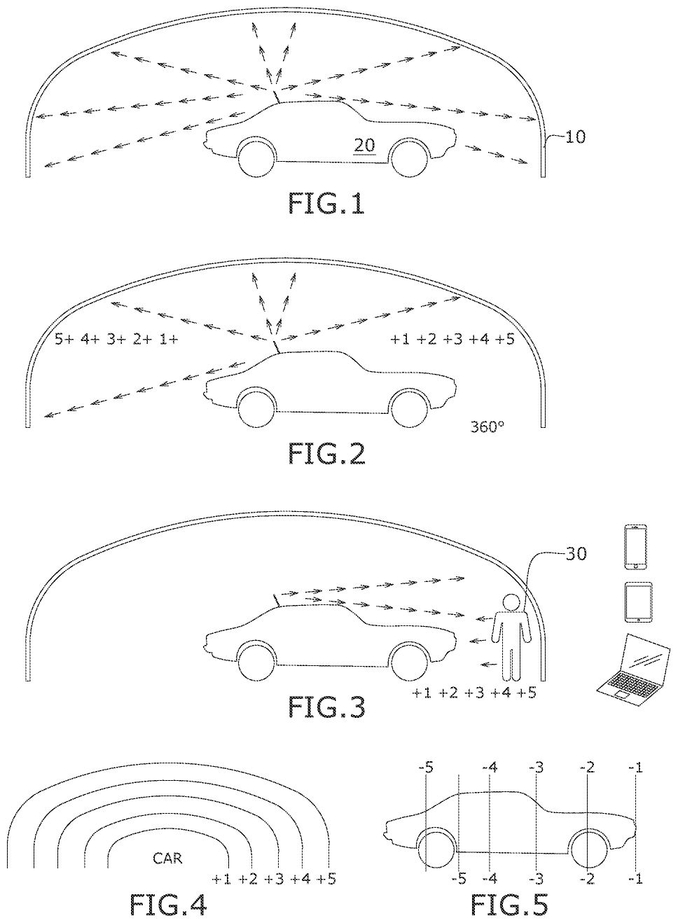

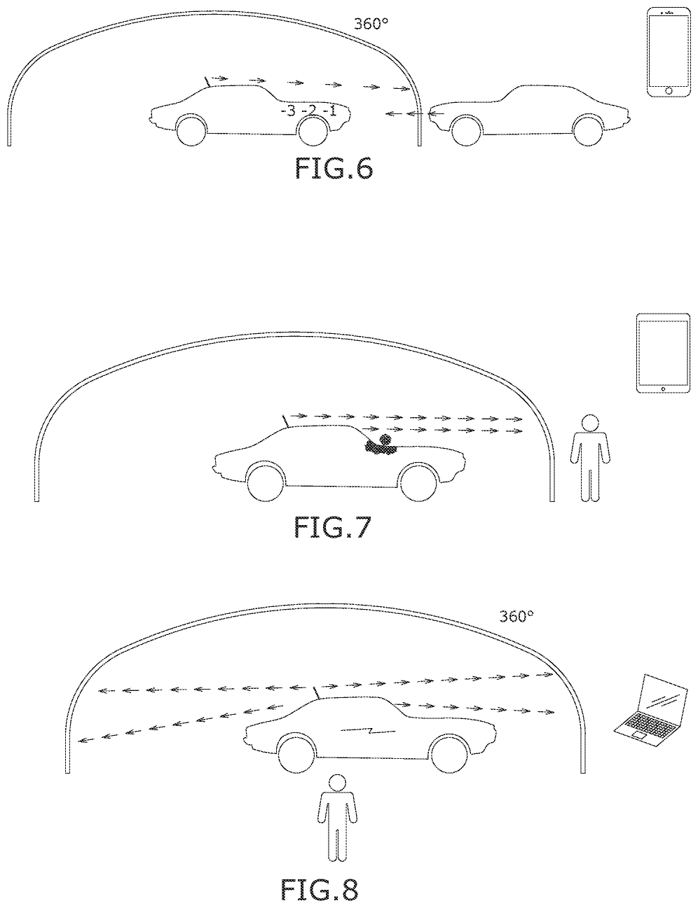

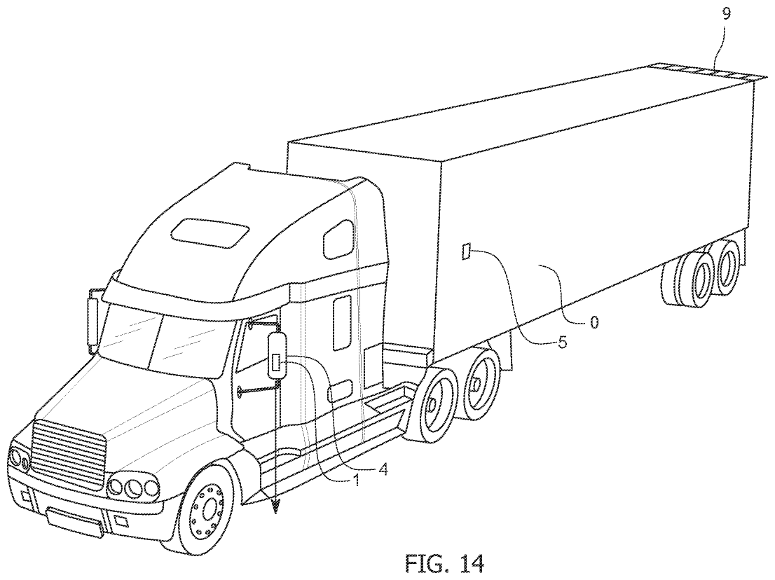

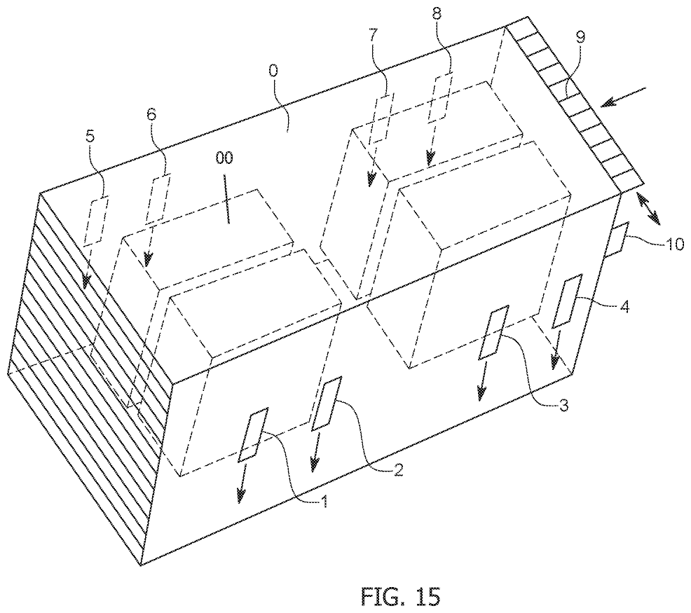

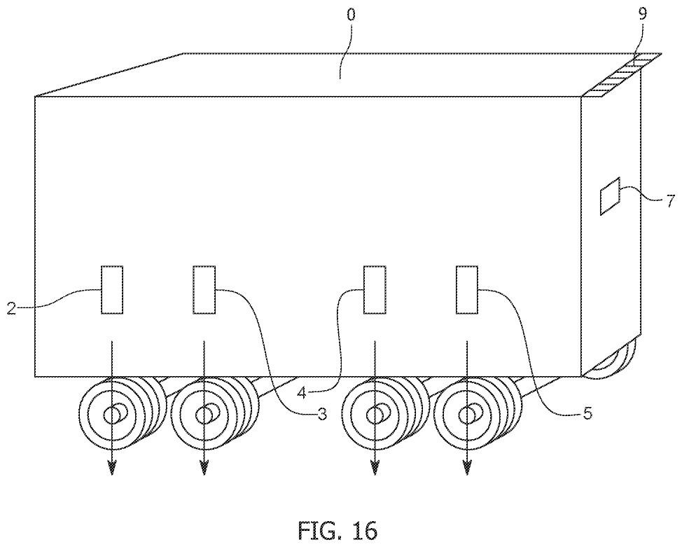

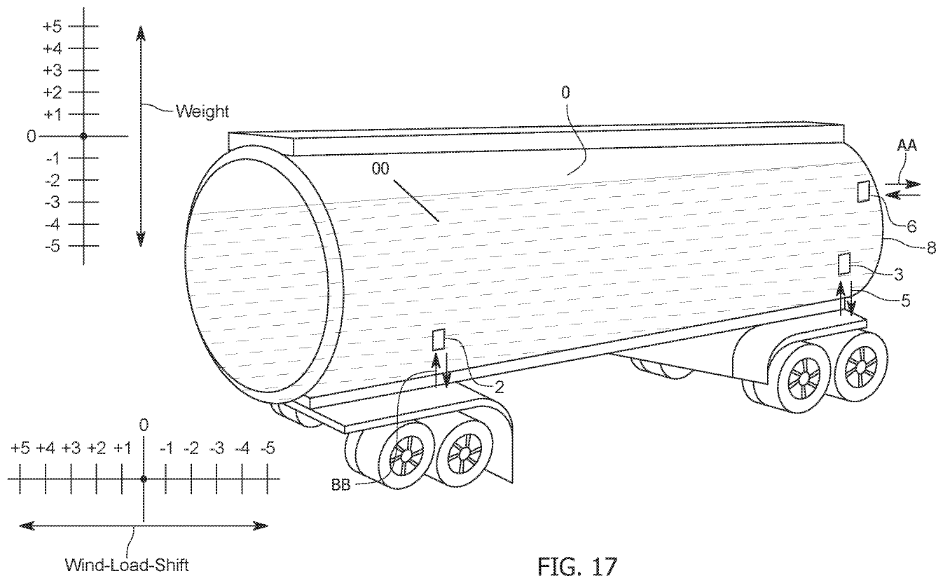

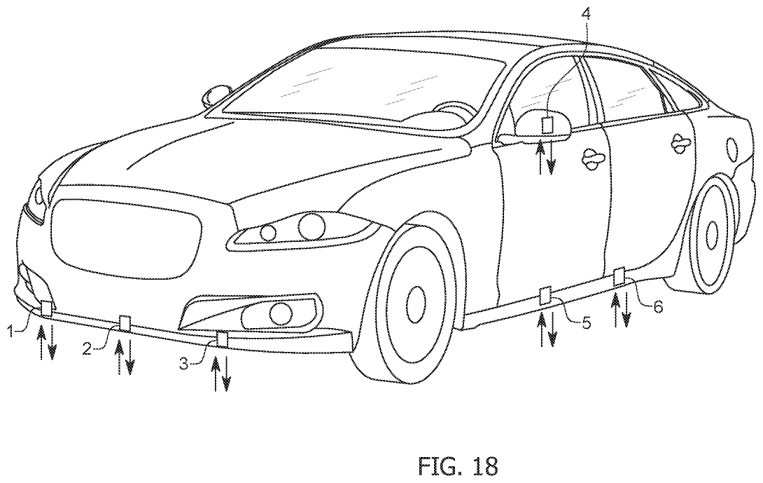

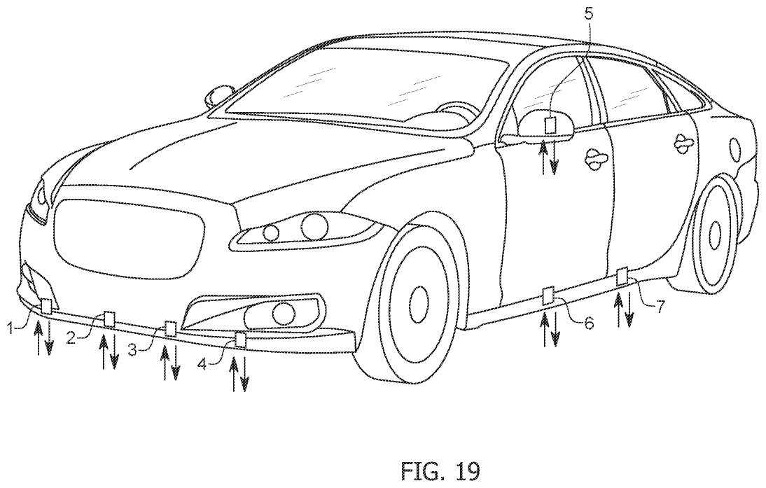

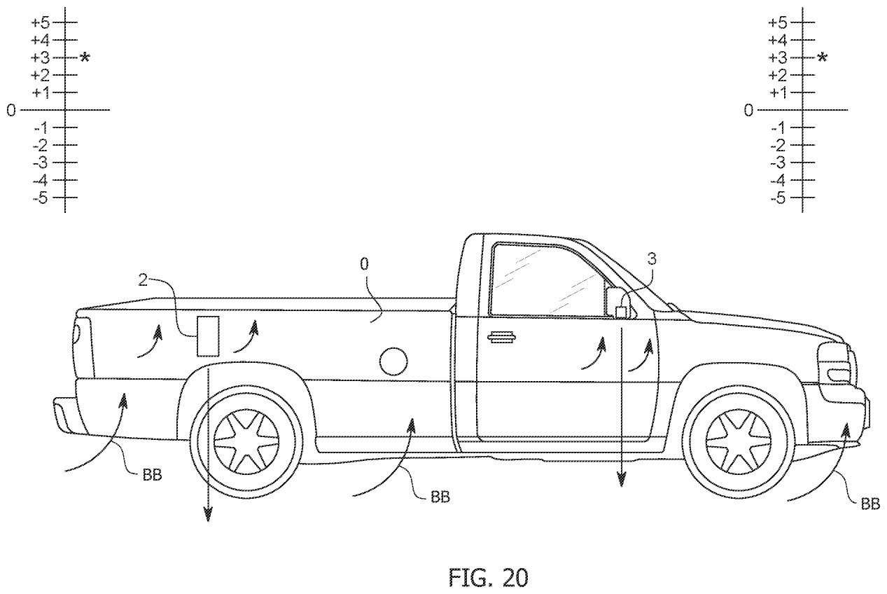

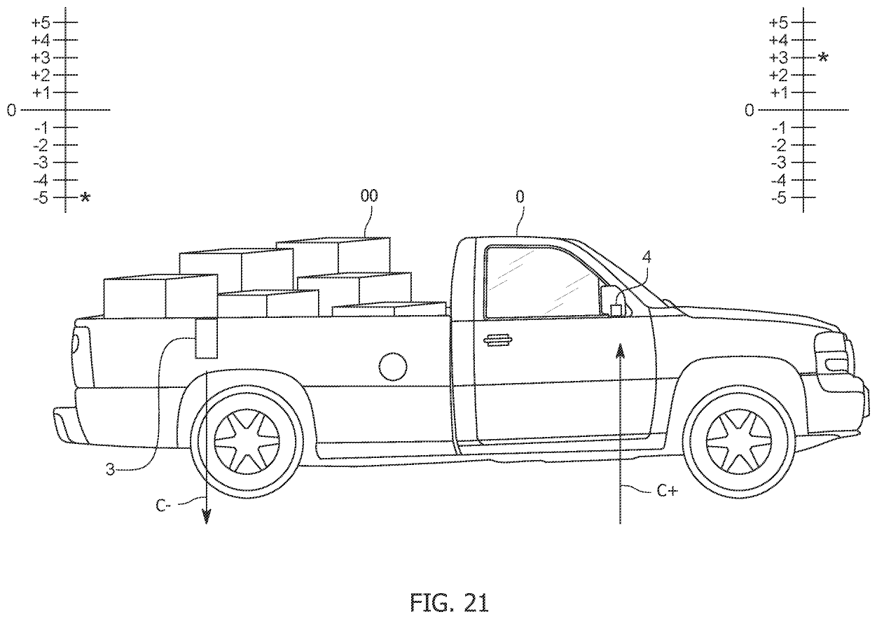

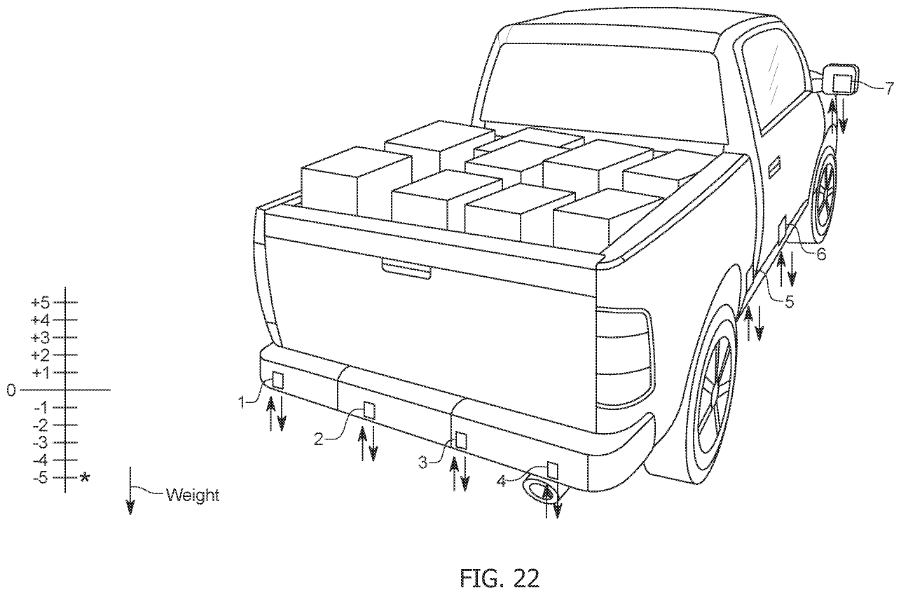

Referring to FIGS. 1 through 22, the present invention may include a proactive vehicular alarm system embodying motion-sensitive audio-video surveillance functionality remotely connected (by way of communication towers 28 standardly used for remote telecommunications, see FIG. 4) to a portable computing device 30 of the vehicle's owner for alerting the owner along in combination with visual and audio data relevant to the event that triggered the alarm system, such as evidence regarding theft and damage to the unattended vehicle.

The audio-video surveillance functionality may be “built-in” or integrated to the vehicle 10 through the selective placement of a plurality of video input devices (e.g., cameras) 12, 14, 16, 18, 32, and 34. The audio-video surveillance functionality may be configured to provide a surveillance coverage area 26 including a bird's eye view of the vehicle 10 as well as a view of an interior of the vehicle.

Portions of the surveillance coverage area 26 are illustrated in FIG. 3, and includes oval or circular portions that are generally centered around each associated video input device 12, 14, 16, 18, 32, or 34; specifically, a rear roof camera 12, a drivers-side mirror camera 14, a passenger-side mirror camera 16, a front camera 18, a rear headliner camera 32, and a rear lower camera 34. Each video input devices may have a housing 20 and a video input lens 22.

Referring to FIG. 2, the front camera 18 integrated with a front grill 24 of the vehicle 10. The rear lower camera 34 may be disposed along a license plate area of the vehicle 10. The interior of the vehicle 10 may be covered with video input surveillance by way of the rear headline camera 32, which may be integrated with a headliner 36 of the interior of the vehicle 10.

The proactive vehicular alarm system may provide one or more motion sensors operatively associated with space immediately adjacent with said vehicle 10. The one or more motion sensors may be coupled to the audio-video surveillance functionality (e.g., video input devices 12, 14, 16, 18, 32, and 34) as well as the (and so possibly retrofitted to a preexisting) alarm system of said vehicle 10, where sufficient motion detected by the one or more motion sensors triggers the proactive vehicular alarm system to provide audio output/alarms and powers the recording of captured images from the audio-video surveillance functionality—capturing images from the exterior of the vehicle 10 (surveillance coverage area 26) and the interior of the vehicle 10. The audio-video surveillance functionality may also be configured to record audio input so as to capture the voice, sounds, and other audible data from an incident that triggers the one or more motion sensors.

The proactive vehicular alarm system may be integrated into the vehicle 10 for safety, style, and convenience. The proactive vehicular alarm system may be in part enabled by wireless communication provided by the vehicle, or the present invention may provide its own wireless communication. The audio-video surveillance system may include a plurality of audio-video input devices, such as sound receivers, microphones, video cameras and the like, built into different portions of the car, configured to create a bird's eye view with night vision and record sound and other audio information. Each camera may be selectively powered and adjusted through software loaded on the portable computing device of a user/owner. Likewise, the present invention enables users to check on their unattended car through the software application.

One camera may be located on the upper rear head liner with a sweeping view, in case of a collision (or if the car is entered without the owner's consent).

The proactive vehicular alarm system may be configured so that if something comes too close to an associated vehicle, the motion sensors are triggered, activating one or more of the audio-video input devices, and exporting an alert with a relevant video-audio clip captured by the one or more audio-video input devices. For example, if driving and a dump truck is dropping debris WIP WATCH will begin recording in case of debris-related damage so that the user can recover/capture, say, a license plate number of the dump truck. In another instance, if there's a crowd walking by a user's car, the audio-visual devices will record for future review is something happens to the automobile.

Because the audio-visual input devices are hidden and/or built into the outside of the car, WIP WATCH can't be stolen like current automobile surveillance devices, like dash cams. Likewise, the present invention has no dash clutter and does not record the driver or road pointlessly for hours, but rather conserves energy and memory space by only recording a predetermined amount of time after the motion sensors are triggers. The present invention can be adapted for new vehicles 10 and retrofitted into aftermarket vehicles 10.

The proactive 360-degree lidar vehicle security system embodies a new use method for identifying objects that come within a selectively defined proximity of the vehicle 20 or within a field of view 10. Within said field of view 10, the coordinates of objects 30 are determined and as a corollary the distance between the object 30 and the vehicle 20 is quantified, and any physical or structural changes such objects 30 may make to the vehicle 20 may also be quantified through the lidar coordinate system.

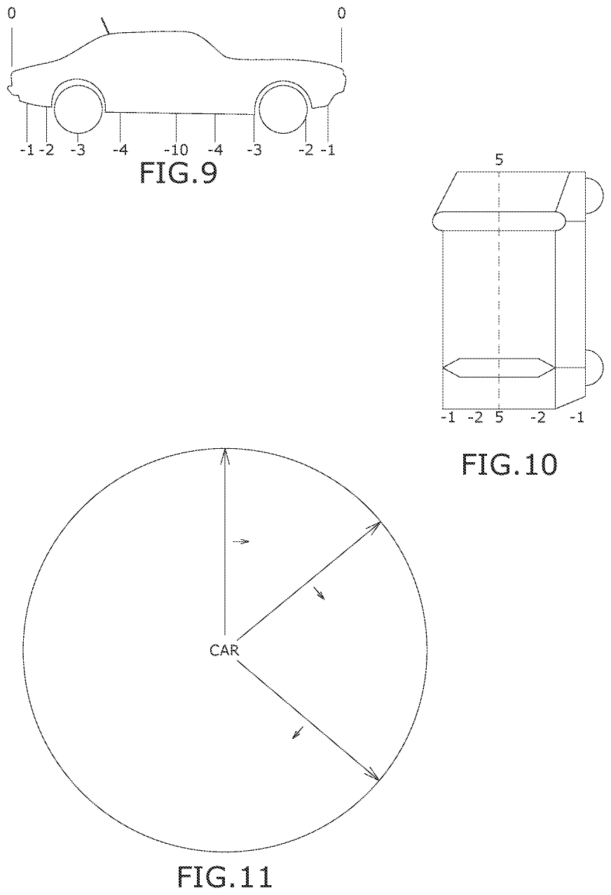

The coordinates of the entirety of an outer vehicle can be divided into zones, in other words zonal coordinates, wherein The coordinates of objects 30 defined in the field of view 10 may be in part a function of the light rays' return path within the field of view 10 and the zonal coordinates, as illustrated in the FIGS. 9-10 and 12-13. Through comparing before and after zonal coordinates the present invention can assess damage by the dimensions of the vehicle 20 and the current structural specifications, which in turn may define the above-mentioned datum for the zonal coordinate. If the current zonal coordinates quantify a negative value relative to an original datum zonal coordinate system, then the damage to the vehicle 20 can be quantified, and any relative positive zonal coordinates is an added object 30 or person engaged on the vehicle 20.

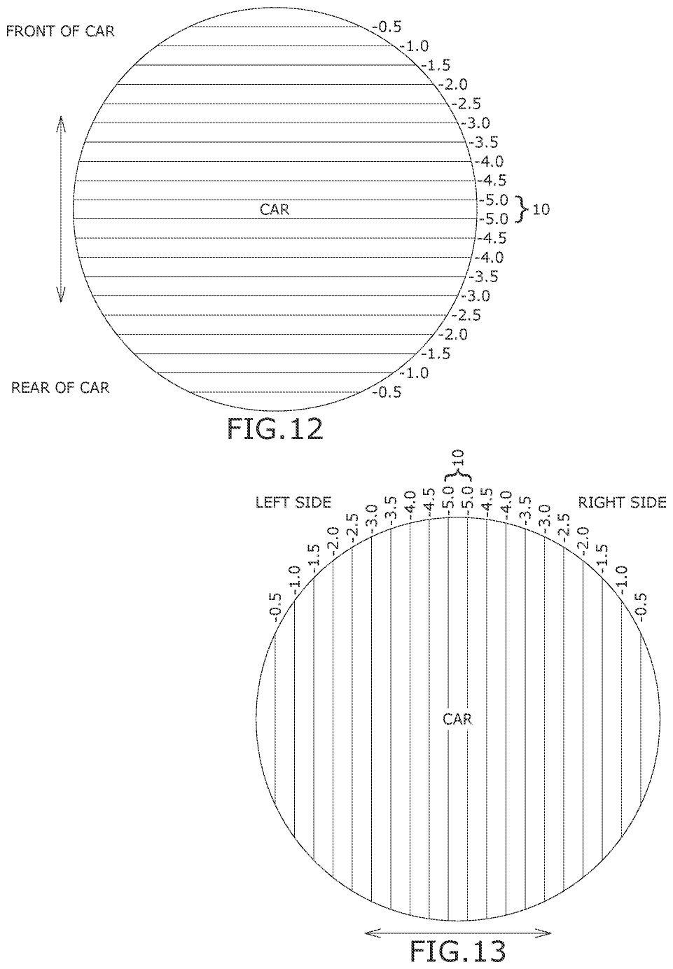

The lidar data captured by the field of view 10 enables a framework, through mapping and scanning software, on which to build a lidar processing workflow including detailed analysis and export functionality in a variety of formats and coordinate systems, whereby the differences in laser return times and wavelengths can then be used to make digital three-dimensional representation of the object 30 in question (which is represented in two dimensions in FIG. 12). The event database enables recording of each incident, in the digital three-dimensional representations, involving one or more objects 30 and the vehicle 20. Each vehicle 20 will have pre-existing vehicular data, including ownership information (title, registration, owner email, owner telephone number, and owner credit card information), insurance information, and structural information (year, make and model, and associated dimensions of the vehicle 20—e.g., datum of zonal coordinates—for assessing future damages that may occur. Any damage that ever occurs to vehicle will be saved in event database for the lifetime of vehicle.

Vehicles 20 equipped with the field of view 10 that are parked in the same vicinity can connect to each other's security system (via a wireless communications system, including but not limited to Bluetooth™) creating a security perimeter between the vehicles 20 using short range radio waves or other wireless communication forms. Infrared beams may create a barrier between the vehicles 20 so that if an object 30 or person crosses the barrier, then the infrared sensors will activate and will start recording (sounding an audible input) and sending notifications to the owner and relevant third parties. For example, at a car lot if there are four vehicles 20, each equipped with the field of view 10 the respective users can park each vehicle at different corners of the lot and the fields of view 10 will connect to each other and create a perimeter around the car lot.

The present invention may include an owner recognition functionality so that the vehicle 20 would be able to use digital photography for facial/body recognition for true keyless entry and operation. In certain applications, if the key is not in vehicle 20 and vehicle 20 is already running it will shut off if unknown person enters driver seat (preventing theft of vehicle 20), and therefore the recognized owner can operate vehicle 20 without key.

The present invention may include a mapping system that allows owners to chart and update outdated or uncharted areas for google maps and ride share services (e.g., UBER™, LYFT™) embodying the pre-existing lidar radar mapping systems and software, such as lidar-based 3D mapping solution, topographic LIDAR mapping using near-infrared light, the above-mentioned mapping and scanning software, a ground version laser scanner (e.g., OPALS™), three-dimensional mapping hardware/laser-scanning system (E.g., LiBackpack™ DG50).

In certain embodiments, the vehicle occupants can use their smart devices to take pictures of different object 30 such as building and landmarks and submit the captured images in question to a “what's that?” functionality that will provide the longitudinal and latitudinal coordinates needed in the above-mentioned disclosure.

In certain embodiment, occupants of the vehicle 20 can stargaze and use a systemic software application on their smart device operatively associated with the field of view 10 for capturing images of different star and/or cluster, and the systemic application will provide longitudinal and latitudinal coordinates along with the time of year to identify the constellations and other heavenly bodies. In some embodiments, circumpolar stars that are seen all year around and southern starts set at the beginning and the end of every night.

In an additional embodiment, the present invention is configured to increase fuel economy for motor vehicles, typically larger motor vehicles, as well as improve traffic safety through real time weight and wind analysis.

A plurality of LIDAR elements 1 through 10, may be disposed along the exterior of the vehicle 0 carrying load 00, wherein the LIDAR elements 1-10 are adapted to sense the elevational shifts of the vehicle 0 (due to its load 00) relative to an elevation supporting surface in the vertical direction, negatively (C+) and positively (C+), or in other words, “sag”. Specifically, the LIDAR elements 1-10 measure the height of the vehicle prior to being occupied and/or loaded and compare it to values associated with the weight for the load 00 (or people being in the vehicle 0). Anything negative (C−) is weight from load 00, and anything positive (C+) is from passengers exiting the vehicle. Moreover, all other measurements by the LIDAR elements 1-10 may be classified as the results of wind velocity AA or BB.

The plurality of LIDAR elements 1 through 10 are configured to determine the sag to weight ratio, using the negative and positive values C− and C+ and associated weight of the load 00, through measuring change in distance from LIDAR element to the ground. Similarly, the LIDAR elements 1-10 may utilize the determined wind velocity (through other sensors) and load shift AA can be measured by horizontal motion.

The LIDAR elements may be attached via leaf springs coil springs, shocks, struts or fixed parts, enabling users to calculate the amount of movement per pound feet of pressure. Whether the movement is longitudinal AA or latitudinal BB, the values in question may be measured. Having the ability to measure the amount of weight in a vehicle (per the maximum load weight indicators) aid in making the sag-to-weight determinations.

The present invention may be relevant for various types of vehicles 0, including vans, pick-up trucks, semitrucks as well as aircrafts, as long as the weight distribution, roll over risk due to sag and wind velocity are a concern.

The LIDAR elements 1-10 may enable the creation of wind maps for traveled terrains, that can be used for the next vehicle 0. The LIDAR elements 1-10 can be configured for passenger use, for instance to determine if kids or groceries have been left in the vehicle 0. The field of view enabled by the LIDAR elements 1-10 would eliminate the use of weight stations, as well as facilitate a system to alert the driver if an underpass is too low or not wide enough for your vehicle to pass. The present invention can increase fuel efficiency by assessing vehicle's the exact amount of weight and wind velocity that is in or affecting their vehicle. The LIDAR elements 1-10 or other sensors will be able to measure the wind velocity in the direction in which is coming from.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A new use for lidar radar for providing a safety system for a vehicle, comprising a plurality of lidar elements disposed along a plurality of exterior surfaces of the vehicle for determining a sag to load ratio, wherein the sag is determined relative between a loaded condition and an unloaded condition of the vehicle.

2. The new use of claim 1, wherein the sag can be determined for each of the plurality of exterior surfaces.
